(19) United States
(12) Patent Application Publication
(10) Pub. No.: US 2023/0252532 A1
(43) Pub. Date: Aug. 10, 2023

(54) METHOD AND SYSTEM FOR AUTOMATED COLLECTIBLE OBJECT GRADING, LABELING, AND ENCAPSULATING

(71) Applicant: AGS, Inc., Staten Island, NY (US)

(72) Inventors: Michael Isakov, Brooklyn, NY (US); Eric Sinko, Norwalk, CT (US); Alex Aleksandrovski, Jersey City, NJ (US)

(21) Appl. No.: 18/107,293

(22) Filed: Feb. 8, 2023

Related U.S. Application Data
(60) Provisional application No. 63/308,036, filed on Feb. 8, 2022.

(51) Int. Cl. G06Q 30/02; G06K 7/14

(52) U.S. Cl. CPC G06Q 30/0278; G06K 7/1413; G06K 7/1417

(57) ABSTRACT

The present invention is a computer-implemented method comprising receiving a notification that a card in received by a grading machine; transferring the card on a platform to a scanning area within the grading machine; capturing a set of data associated with the card via a plurality of sensors and cameras of the grading machine; determining that the set of data associated with the card is accurate and without errors; analyzing the set of data to identify defects of the card; generating a label based on the identified defects; and encapsulating the card and the label in a slab, wherein the slab contains identifying information.

### CROSS-REFERENCE TO RELATED APPLICATIONS

This application is a continuation-in-part (and claims the benefit of priority under 35 USC 120) of U.S. application No. 63/308,036 filed Feb. 8, 2022. The disclosure of the prior applications is considered part of (and is incorporated by reference in) the disclosure of this application.

### BACKGROUND

This disclosure relates generally a device to authentic collectibles, and more specifically to a method and system that would grade collectable items to determine the authenticity of said item.

Trading cards, trading card games, and collectible cards have been a staple of the collectible community for over 100 years, having grown into a $370B industry. Trading cards capture a moment in time, often representing a moment in time, a sport, game, fictional, or non-fictional genre. These collectibles hold immense vintage, nostalgic, and antique value and often can be worth in the millions for a single card.

Collective value assignment and authenticity of collectibles is a major concern for market participants. Fraudsters often attempt to make fake cards or conceal the damage of a card. Damages and defects indicate the value of a card based on a numeric “grade” and subsequent subgrades, which represent categories of quality (e.g., centering, edges, corners, surface). Many companies exist in the market which perform “grading” of cards in which the company as a third party reviews the card confirming authenticity, assessing damages, slabbing or encapsulating the card in a plastic slab, and assigning a grade to the card. Some groups in previous art (included) have sought computerized methods of performing the “grade”. Using a camera alone is not a novel approach to scan a card, as the same method is used throughout a multitude of defect detection applications.

Grading is an effectively manual process. There are many complications in automating the grading process, particularly in physically handling the card (including flipping the card), deciding which data to acquire from the card, deciding the methods to acquire that data, processing that data using methods that scale, providing error handling and continuity conditions for bulk grading, and much more.

Grading cards is based on various characteristics that pertain to the “general eye appeal” of the card. Characteristics of the card that are universally examined in the grading process are centering, corners, edges, and surface. Centering is the placement of the image (top to bottom and left to right) on the card relative to the card borders. Industry standards exist for percentage of off centering variance permitted for each of the possible card grades. The corners of the card are inspected to determine the quality of the physical condition of the corner and/or if any defect of the corners is present. The edges of the card are examined, similarly as the corners, to determine the quality of the physical condition of the edges of the card, and account for any damages and/or imperfections along the edges. The surface of the card is examined to account for any damage and/or imperfections on the card, such as scratches, creases, tears, pinholes, stains, dents, attempts at recoloring, etc.

Grading is, with extremely rare exception, the most significant determination of value, such fluctuations in grading often result in misstatement of value and lack of confidence in the marketplace necessary to sustain a stable and efficient market.

Therefore, it is desired for an autonomous solution that would handle the entire grading process.

### SUMMARY

In a first embodiment, the present invention is a computer-implemented method comprising: receiving, by at least one processor, a notification that a card in received by a grading machine; transferring, by the at least one processor, the card on a platform to a scanning area within the grading machine; capturing, by the at least one processor, a set of data associated with the card via a plurality of sensors and cameras of the grading machine; determining, by the at least one processor, that the set of data associated with the card is accurate and without errors; analyzing, by the at least one processor, the set of data to identify defects of the card; generating, by the at least one processor, a label based on the identified defects; and encapsulating, by the at least one processor, the card and the label in a slab, wherein the slab contains identifying information.

In a second embodiment, the present invention is a computer program product for grading a collectible, the computer program product comprising: a computer non-transitory readable storage medium having program instructions embodied therewith, the program instructions executable by a computing device to cause the computing device to: receiving a set of data associated with a collectible, wherein the set of data includes a plurality of images of the collectible and at least one scan of the collectible; analyzing the set of data to determine if the accuracy of the plurality of images and the at least one scan is of a predetermined level; calculating a set of grades of the collectible based on an analysis of the set of data, wherein the set of data is analyzed to identify defects and a severity of the identified defects; converting the set of grades into an overall grade of the card and storing the set of grades and the overall grade; and generating a label containing at least the overall grade.

In a third embodiment, the present invention is a system comprising: a grading machine for receiving a collectible and generating images and scans of the collectible by a series of image and data capturing devices and sensors; a computing device comprising at least one processor for collecting the series of images and data; a processing module to analyze the collected series of images and data to determine any defects or irregularities of the collectible and generate a data set; a labeling machine, capable of receiving the data set and generate label; and an encapsulating machine, wherein the collectible and the label are sealed within a tamper proof case.

### BRIEF DESCRIPTION OF THE DRAWINGS

FIG. 1 depicts a block diagram depicting a computing environment, according to an embodiment of the present invention.

FIG. 2 depicts a block diagram depicting a computing environment, according to another embodiment of the present invention.

FIG. 3 depicts a block diagram of a mobile device, according to an embodiment of the present invention.

FIG. 4 depicts a block diagram of a computing device, according to an embodiment of the present invention.

FIG. 5 depicts a cloud computing environment, according to an embodiment of the present invention.

FIG. 6 depicts a flowchart of an autonomous process for grading, labeling, and encapsulating a collectible object, according to an embodiment of the present invention.

FIG. 7 depicts a flowchart of an input process of the autonomous process, according to an embodiment of the present invention.

FIG. 8 depicts a flowchart of a grading process of the autonomous process, according to an embodiment of the present invention.

FIG. 9 depicts a flowchart of a labeling process of the autonomous process, according to an embodiment of the present invention.

FIG. 10 depicts a flowchart of an encapsulating process of the autonomous process, according to an embodiment of the present invention.

FIG. 11 depicts a block diagram of a grading machine, according to an embodiment of the present invention.

FIG. 12 depicts an isometric view of the grading machine, according to an embodiment of the present invention.

FIG. 13 depicts an isometric view of the grading machine, according to an embodiment of the present invention.

FIG. 14 depicts an isometric view of a grading machine, according to another embodiment of the present invention.

FIG. 15 depicts an isometric view of the grading machine, according to another embodiment of the present invention.

### DETAILED DESCRIPTION

The present invention relates to an automated machine system that automatically scans, grades, and slabs collectibles and the methods associated. The system is a combination of hardware and software components including but not limited to lasers, cameras, chemical sensors, microscopy, light spectroscopy, machine learning techniques, artificial intelligence, computer vision, advanced robotics assemblies and actuators, and surrounding computing and mechanical infrastructure. The primary embodiment relates to trading cards, although the system and processes are applicable to all collectibles including coins, large 3D objects, stamps, comics, and more.

Trading and collectible card enthusiasts desire cards that are in the finest condition. Collectors do not want to overpay for a low-quality card or sell a high-quality card for less than it is worth. In the approximately $13 billion industry, some of these cards can be valued well over tens of thousands of dollars. The condition of these cards is the main driver of their value. Improper grading of the condition of these cards by professional graders can result in thousands of dollars of undervalued or overvalued cards.

Currently, commercial and private grading companies use professional graders to manually grade many cards. Experienced graders can spot the smallest of imperfections that can affect the value of a card by hundreds or thousands of dollars. Experience is therefore the most important quality of a professional grader, however the professional grader is subjective. What the industry is lacking is the experience of a professional grader with an objective view of the card grading. This is the advantage of the present invention.

Grading of a card is currently performed by the human eye and there is much subjectivity involved in grading. If the same card is graded twice by a grading company, it is highly likely that the grades obtained for the same card during two different grading sessions are different. In an embodiment, the invention is grading sports cards on a 10-point scale based on the condition of the card, fully by computers and by automation. Fully automated and computer-based grading will bring in complete objectivity to the market and have a standard that is set in the process. In automated grading, when a card is run through the machine, it provides an accurate readout of the condition, and provides a grade. Next time when the same card is run through the machines, as long as there is no further damage or there is no change in the condition of the card during the process of removing it from the case and putting it back in, the grade will remain the same. This is not the case when a grade of the card is generated by a person. Thus, with the automated process of grading, the human element in assessing the grade or condition of the card is removed, and the value depend on purely the condition of the card from an objective point of view.

Grading of cards is based on various characteristics that pertain to the general eye appeal of the card. Characteristics of the card that are universally examined in the grading process are centering, corners, edges, and surface. Centering is the placement of the image (top to bottom and left to right) on the card relative to the card borders. Industry standards exist for percentage of off centering variance permitted for each of the possible card grades. The corners of the card are inspected to determine the quality of the physical condition of the corner and/or if any defect of the corners is present. The edges of the card are examined, similarly as the corners, to determine the quality of the physical condition of the edges of the card, and account for any damages and/or imperfections along the edges. The surface of the card is examined to account for any damage and/or imperfections on the card, such as scratches, creases, tears, pinholes, stains, dents, attempts at recoloring, etc.

While the device will be grading the condition of the card, it is important that the device is a safe environment for all cards. Essentially, the card is not to be damaged inside the device while being handled by a human or a machine. All damage to the card must be prevented, and the card should be handled minimally by both man and machine. The operator touches the card twice, once when inserting the card into the system, and once when removing it. While the card is inside the machine, it gathers data for assessing the condition of the card. The device scans both sides of the card and the edges with all cameras/sensors. In addition to the detection of physical defects/damages, the device can detect the centering of the image on the card to the nearest 0.025 mm. It further evaluates any defects or damages present on the surface or anywhere on the card.

In an embodiment, the device takes about a minute to scan, compute, process, and output the card condition data. Moreover, the machine exhibits a long runtime and doesn't freeze or require reset after a few grading cycles. The device can be operated continuously for many hour, days, weeks, even years without any issues.

Since the biggest issue with card grading has to do with the subjectivity of the grading process, the device eliminates subjectivity by objectively collecting the card condition data and processing all collected data. The device produces similar data and grades for a card when tested more than once.

Cards are generally graded based on the primary attributes of Centering, Corners, Edges, and Surface. Sometimes autographs are also included in the analysis. Each attribute is generally given a grade of 1-10 and then combined to get the overall final grade of the card on a scale of 1-10. The attributes may vary in weight based on the type of card, but overall these attributes are analyzed for the grading process.

Centering: Centering is basically the width of the border. Ideally, the border sizing should be equal on the left, right, top and bottom. Sometimes judging the centering won't be as simple as looking for equal spaced borders. The ultimate criterion is that the card should feel balanced. If a card appears lopsided, this means the centering is off. Additionally, how parallel the left/right and top/bottom inner border lines of the card are taken into consideration. This is related to the “angle” deviation of the card. A zero (0) angle deviation correlates with a perfect score. This “angle” is coupled with the spacing mentioned in this paragraph to determine centering.

Corners: A card with four sharp corners can alleviate other concerns, especially on older cards. All four corners are analyzed looking at the front of the card and then looking at the back of the card. All the corners are checked for any imperfections either on one side or on both sides.

Edges: The four edges of a card are important. Edges should be sharp, and the color should be constant. Edges are observed for imperfections such as peeling off, dings, dents, or subtle discolorations.

Surface: Surface is the condition of the card considered as a whole. Cards are observed for glossy finish, scratches on the surface, and faded autographs. If the card is made of foil stock, they are observed for imperfections or defects like small pieces of foil coming off, leaving white specks on the card. The cards are observed for creases, moisture damage, factory print lines, dirt, general whitening, tears, holes, stains, ink smearing, and stamp marks. Many times, a crease is hard to notice, as the picture on a card can hide one very well.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first”, “second”, “third”, “fourth”, and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include” and “have”, and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left”, “right”, “front”, “back”, “top”, “bottom”, “over”, “under”, and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has”, “have”, “having”, or the like are intended to be open-ended terms. Further, the phrase “based on” is intended to mean “based, at least in part, on” unless explicitly stated otherwise.

The terms “couple”, “coupled”, “couples”, “coupling”, and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably”, “removable”, and the like near the word “coupled”, and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

As used herein, the term component is intended to be broadly construed as hardware, firmware, and/or a combination of hardware and software.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to a suitable receiver apparatus.

The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, for example without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

The foregoing disclosure provides illustration and description, but is not intended to be exhaustive or to limit the implementations to the precise form disclosed. Modifications and variations are possible in light of the above disclosure or may be acquired from the practice of the implementations.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects may generally be referred to herein as a “circuit,” “module”, or “system.” Furthermore, aspects of the present invention may take the form of a computer program product embodied in one or more computer readable medium(s) having computer readable program code/instructions embodied thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

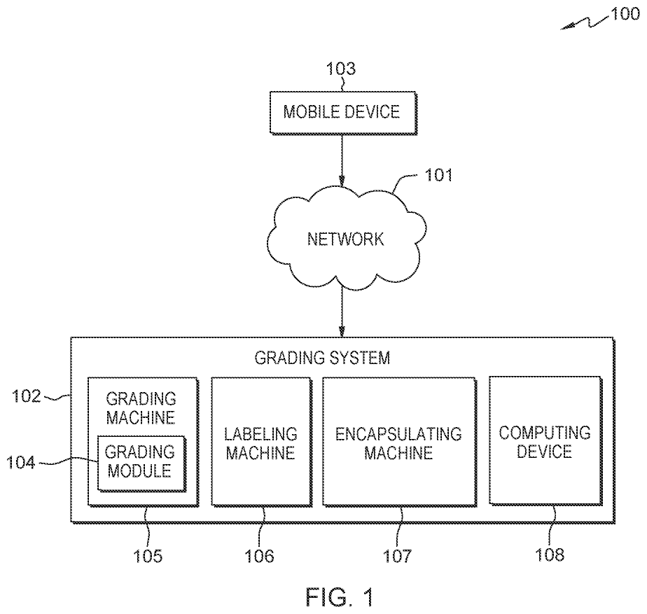

FIG. 1 depicts a block diagram of a computing environment 100 in accordance with one embodiment of the present invention. FIG. 1 provides an illustration of one embodiment and does not imply any limitations regarding the environment in which different embodiments may be implemented.

In the depicted embodiment, computing environment 100 includes network 102, mobile device 103, and grading system 10105. Computing environment 100 may include additional servers, computers, or other devices not shown.

Network 102 may be a local area network (LAN), a wide area network (WAN) such as the Internet, any combination thereof, or any combination of connections and protocols that can support communications between mobile device 103 and grading system 102 in accordance with embodiments of the invention. Network 102 may include wired, wireless, or fiber optic connections.

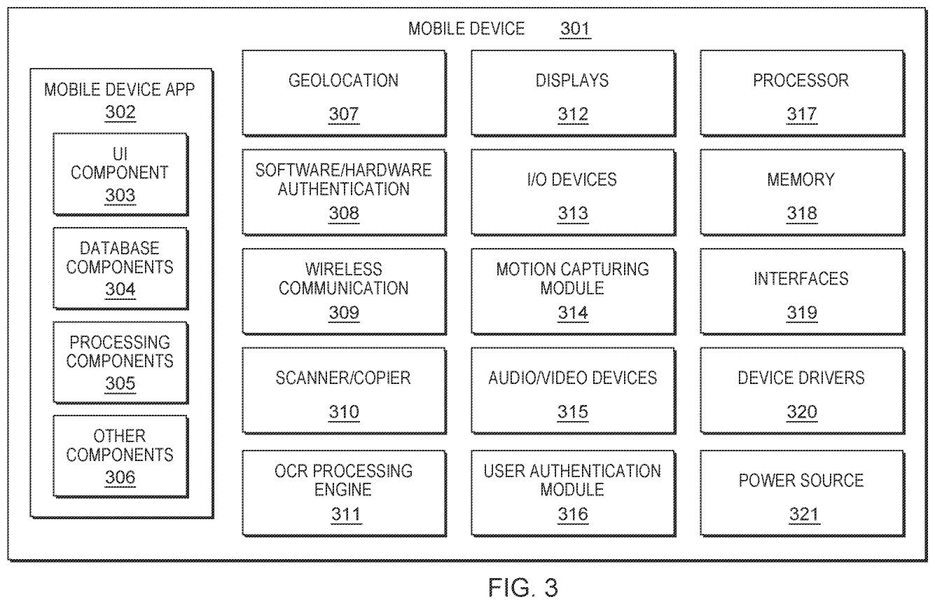

Mobile device 103 may be a management server, a web server, or any other electronic device or computing system capable of processing program instructions and receiving and sending data. In some embodiments, mobile device 103 may be a laptop computer, tablet computer, netbook computer, personal computer (PC), a desktop computer, or any programmable electronic device capable of communicating with personnel computing device 106 and server 105 via network 102. In other embodiments, mobile device 103 may represent a server computing system utilizing multiple computers as a server system, such as in a cloud computing environment. In another embodiment, mobile device 103 represents a computing system utilizing clustered computers and components to act as a single pool of seamless resources. In embodiments, mobile device 103 may include any combination of grading module 104 or database 114. mobile device 103 may include components, as depicted and described in further detail with respect to FIG. 3.

Grading System 102 is comprised of a grading machine 102, a labeling machine 10, an encapsulating machine 107, and a computing device 280. The grading system 102 provides for the equipment required to analyze the card to calculate the grading score, generating the label to attached to the card, and encapsulating the card and the label. The grading system 102 is capable of communicating with the mobile device 103 via network 102. In the depicted embodiment, the grading machine 102, a labeling machine 10, an encapsulating machine 107, and a computing device 280 are a single piece of machinery that is able to perform all the of the autonomously and transfer the card directly from one piece of equipment to the next this removes the need for a person or operator to transfer the card from machine to machine, thus removing opportunity for the card to be damaged during the process.

Grading Machine 105 provides the machine that receives the card or collectible and performs the analysis of the card to determine the score/grade of the card. This is performed by taking a plurality of images, scans, and data which is captured by a plurality of cameras of similar or different types, lasers, light sensors, force sensors, pressure sensors, video camera, an infra-red camera, an ultra-violet camera, a vision system, a lighting system, laser range finders, and the like. This data is then processed through the module to determine the grade of the card. The grading process is performed using artificial intelligence or computer learning to generate a defect map, and using that defect map to grade the card.

Labeling Machine 10 generates and prints the label which is based on the grading machine 105 analysis of the card. The label is based on the desired information which is to be contained in the label. For instance, the label can provide the date, time, grading score, and card information. As well as a QR code, or other etching to include additional information.

Encapsulating Machine 107 provides for the machine which encapsulates the card and the label within a seal protective case. The sealing of the card with the label provides added protection to both the card and the grading score. Given that the protective case is tamper proof, if the case is opened, the protective case provides a visual queue to alert others that the grading score of the card may be invalidated due to the card being removed from the case and subject to additional damage or wear. A tamper proof casing may be equipped with one or more of tamper resistant, tamper detection, tamper response, and tamper evidence. It may also mean a case or device where tamper is evident and may or may not be tamper resistant.

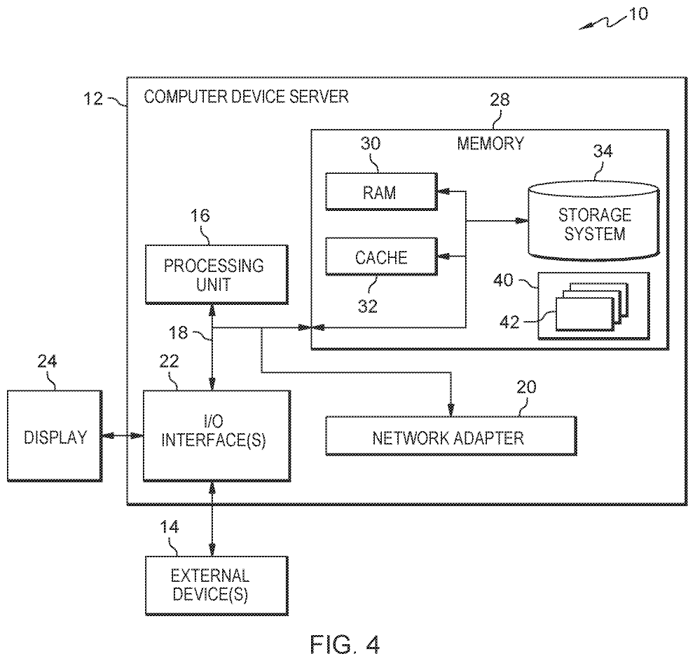

Computing device 280 may be a management server, a web server, or any other electronic device or computing system capable of processing program instructions and receiving and sending data. In other embodiments, computing device 280 may be a laptop computer, tablet computer, netbook computer, personal computer (PC), a desktop computer, or any programmable electronic device capable of communicating with the grading system 102, the grading machine 105, the labeling machine 10, the encapsulating machine 107, or the mobile device 103 via network 102 or through direct connection. In other embodiments, computing device 280 may be a server computing system utilizing multiple computers as a server system, such as in a cloud computing environment. In one embodiment, computing device 280 represents a computing system utilizing clustered computers and components to act as a single pool of seamless resources. computing device 280 may include components, as depicted and described in further detail with respect to FIG. 4.

Grading Module 110 operates to perform the operational steps of the grading system 102 and perform the grading analysis of the card. In the depicted embodiment, the grading module 110 is on the computing device 280 and utilizes network 102 to access the mobile device 103. In one embodiment, grading module 110 resides on the mobile device 103. In other embodiments, grading module 110 may be located on another server or computing device, provided grading module 110 has access to the database 114, and the grading system 102.

Database 114 may be a repository that may be written to and/or read by grading module 110. Information gathered from the grading module 110 and the grading system 102 may be stored to database 114. In one embodiment, database 114 is a database management system (DBMS) used to allow the definition, creation, querying, update, and administration of a database(s). In the depicted embodiment, database 114 resides on server 105. In other embodiments, database 114 resides on another server, or another computing device, provided that database 114 is accessible to grading module 110.

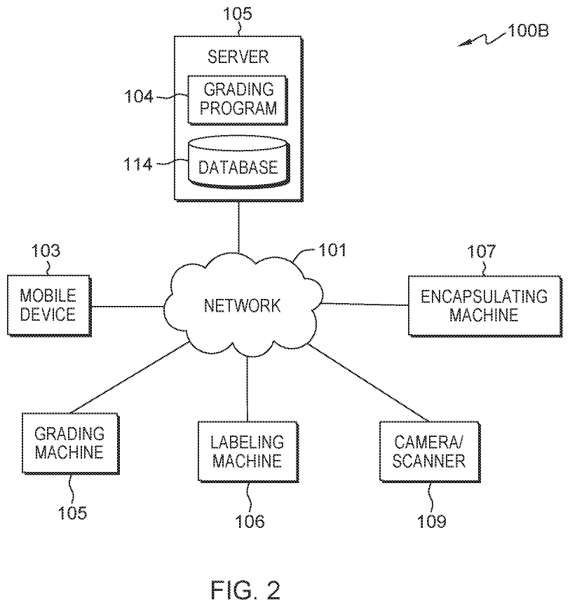

FIG. 2 depicted another embodiment of a block diagram of a computing environment 100B in accordance with one embodiment of the present invention. In the present embodiment, the computing environment 100B is comprised of a network 102, server 105, a mobile device 103, a grading machine 105, a labeling machine 10, an encapsulating machine 280, and a camera/scanner 109.

The grading machine 105, the labeling machine 10, and the encapsulating machine 280 are all separate machines that communicate with the database 114 and the grading module 104 via network 102. This embodiment requires a person or external piece of machinery to transfer the card from one machine to the next. In some embodiments, a machine is positioned relative to all three machines to transfer the card from one to the next. The grading machine 105, the labeling machine 10, and the encapsulating machine 280 all have the necessary computing devices and components to communicate with the server 105 via network 102. The camera/scanner 109 is used to capture an image or scan of the card once it is encapsulated.

Server 105 may be a management server, a web server, or any other electronic device or computing system capable of processing program instructions and receiving and sending data. In other embodiments server 105 may be a laptop computer, tablet computer, netbook computer, personal computer (PC), a desktop computer, or any programmable electronic device capable of communicating via network 102 with the mobile device 103, the grading machine 105, the labeling machine 10, and the encapsulating machine 280. In one embodiment, server 105 may be a server computing system utilizing multiple computers as a server system, such as in a cloud computing environment. In one embodiment, server 105 represents a computing system utilizing clustered computers and components to act as a single pool of seamless resources. In the depicted embodiment database 114 and grading module 104 are located on server 105. Server 105 may include components, as depicted and described in further detail with respect to FIG. 4.

Referring to FIG. 3 depicts a mobile device 300. A mobile device app 302 component can be provided for download by a service provider, such as an app store for smart phone devices. Various aspects, features, and/or functionalities of client system 300 may be performed, implemented and/or initiated by one or more of the following types of systems, components, systems, devices, procedures, processes, and the like. Such items can include, for example: Processor(s) 317, Device Drivers 320, Memory 318, Interface(s) 319, Power Source 321, Geolocation module 307, Display(s) 312, I/O Devices 313, Audio/Video devices(s) 315, Motion Detection module 314, User Identification/Authentication module 316, Software/Hardware Authentication/Validation 308, Wireless communication module(s) 309, Scanner/Camera 310, OCR Processing engine 311, and the like.

As illustrated in the example of FIG. 3, mobile device 300 may include a variety of components, modules and/or systems for providing various functionalities. For example, Mobile Device 300 may include Mobile Device Application components (e.g., 302), which, for example, may include, but are not limited to, one or more of the following (or combinations thereof): UI Components 303, Database Components 304, Processing Components 305, and Other Components 306 which, for example, may include components for facilitating and/or enabling the mobile device to perform and/or initiate various types of operations, activities, functions such as those described herein. In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, different types of components, modules and/or systems (or combinations thereof) such as, for example, one or more of the following.

At least one processor 317. In at least one embodiment, the processor(s) 317 may include one or more commonly known CPUs that are deployed in many current consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile random access memory (“RAM”) and/or read only memory (“ROM”)) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.

Memory 318, which, for example, may include volatile memory (e.g., RAM), non-volatile memory (e.g., disk memory, FLASH memory, EPROMs, etc.), unalterable memory, and/or other types of memory. In at least one implementation, the memory 318 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various Automated Card Grading System components described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the Automated Card Grading System components described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM devices. Examples of program instructions include both machine code, such as produced by a compiler, and files containing higher level code that may be executed by the computer using an interpreter.

Interface(s) 319 which, for example, may include wired interfaces and/or wireless interfaces. In at least one implementation, the interface(s) 319 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™) 802.16 (WiMax), 802.22, Cellular standards such as CDMA, CDMA2000, WCDMA, Radio Frequency (e.g., RFID), Infrared, Near Field Magnetics, and the like.

Device driver(s) 320. In at least one implementation, the device driver(s) 320 may include functionality similar to at least a portion of functionality implemented by one or more computer system driver devices such as those described herein and/or generally known to one having ordinary skill in the art.

At least one power source (and/or power distribution source) 321. In at least one implementation, the power source may include at least one mobile power source (e.g., battery) for allowing the client system to operate in a wireless and/or mobile environment. For example, in one implementation, the power source 321 may be implemented using a rechargeable, thin-film type battery. Further, in embodiments where it is desirable for the device to be flexible, the power source 321 may be designed to be flexible.

Geolocation module 307 which, for example, may be configured or designed to acquire geolocation information from remote sources and use the acquired geolocation information to determine information relating to a relative and/or absolute position of the client system.

Motion detection component 314 for detecting motion or movement of the client system and/or for detecting motion, movement, gestures and/or other input data from user. In at least one embodiment, the motion detection component 314 may include one or more motion detection sensors such as, for example, MEMS (Micro Electro Mechanical System) accelerometers, that can detect the acceleration and/or other movements of the client system as it is moved by a user.

One or more display(s) 312. According to various embodiments, such display(s) may be implemented using, for example, LCD display technology, OLED display technology, and/or other types of conventional display technology. In at least one implementation, display(s) 312 may be adapted to be flexible or bendable. Additionally, in at least one embodiment the information displayed on display(s) 312 may utilize e-ink technology (such as that available from E Ink Corporation, Cambridge, Mass., www.eink.com), or other suitable technology for reducing the power consumption of information displayed on the display(s) 335.

User Identification/Authentication module 167. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user that provides a wireless signal to the client system for determining the identity of the current user. In at least one implementation, various security features may be incorporated into the client system to prevent unauthorized users from accessing confidential or sensitive information.

One or more user I/O Device(s) 313 such as, for example, keys, buttons, scroll wheels, cursors, touchscreen sensors, audio command interfaces, magnetic strip reader, optical scanner, etc.

Audio/Video device(s) 315 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.

Wireless communication module(s) 309. In one implementation, the wireless communication module 309 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.

Software/Hardware Authentication/validation components 308 which, for example, may be used for authenticating and/or validating local hardware and/or software components, hardware/software components residing at a remote device, user information and/or identity, etc.

Scanner/Camera Component(s) (e.g., 310) which may be configured or designed for use in scanning identifiers and/or other content from other devices and/or objects such as for example: mobile device displays, computer displays, static displays (e.g., printed on tangible mediums), or any other means of scanning taking a picture, or otherwise forming an image of a collectible to be graded by the system.

OCR Processing Engine (e.g., 311) which, for example, may be operable to perform image processing and optical character recognition of images such as those captured by a mobile device camera, for example.

Referring now to FIG. 4, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer device/server 12, which is operational with numerous other general purpose or special purpose computing system environments or configurations. Examples of well-known computing systems, environments, and/or configurations that may be suitable for use with computer device/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

computer device/server 12 may be described in the general context of computer system executable instructions, such as program modules, being executed by a computer system. Generally, program modules may include routines, programs, objects, components, logic, data structures, and so on that perform particular tasks or implement particular abstract data types. computer device/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer device/server 12 in cloud computing node 10 is shown in the form of a general-purpose computing device. The components of computer device/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

computer device/server 12 typically includes a variety of computer system readable media. Such media may be any available media that is accessible by computer device/server 12, and it includes both volatile and non-volatile media, removable and non-removable media.

System memory 28 can include computer system readable media in the form of volatile memory, such as random access memory (RAM) 30 and/or cache memory 32. computer device/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

computer device/server 12 may also communicate with one or more external devices 14 such as a keyboard, a pointing device, a display 24, etc.; one or more devices that enable a user to interact with computer device/server 12; and/or any devices (e.g., network card, modem, etc.) that enable computer device/server 12 to communicate with one or more other computing devices. Such communication can occur via Input/Output (I/O) interfaces 22. Still yet, computer device/server 12 can communicate with one or more networks such as a local area network (LAN), a general wide area network (WAN), and/or a public network (e.g., the Internet) via network adapter 20. As depicted, network adapter 20 communicates with the other components of computer device/server 12 via bus 18. It should be understood that although not shown, other hardware and/or software components could be used in conjunction with computer device/server 12. Examples, include, but are not limited to: microcode, device drivers, redundant processing units, external disk drive arrays, RAID systems, tape drives, and data archival storage systems, etc.

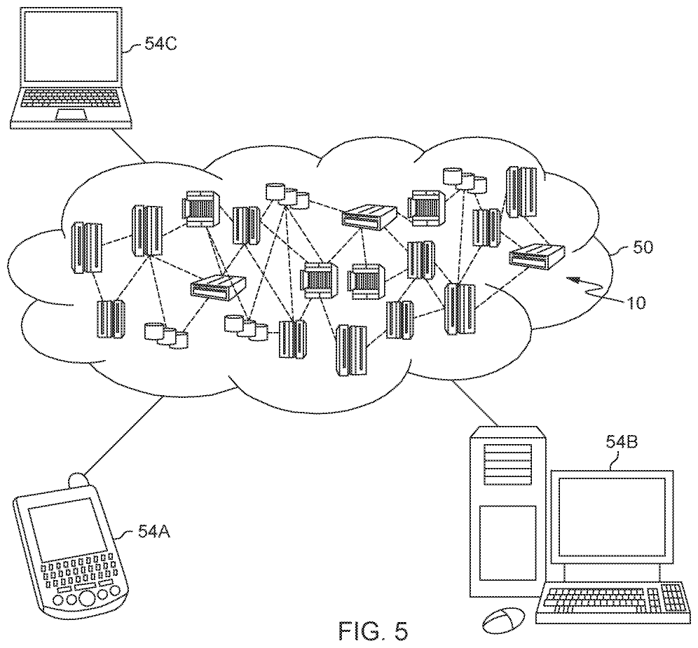

Referring now to FIG. 5, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

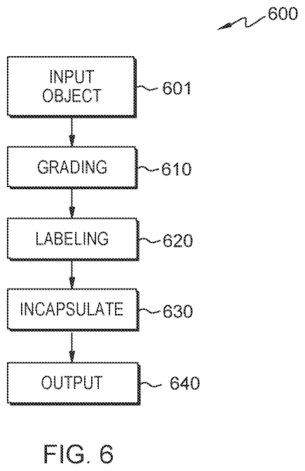

Referring to FIG. 6 shows flowchart 600 depicting a method according to the present invention. The method(s) and associated process(es) are now discussed, over the course of the following paragraphs, with extensive reference to FIGS. 6-10, in accordance with one embodiment of the present invention. The process comprising the steps of input 601, grading 610, labeling 620, encapsulating 630, and output 640. The output 640 is the final product of the card encapsulated in the case with the label and the other identify information and the captured images or scans of the encapsulated card. At this step a notification or alert is sent to the mobile device 103 to information the owner of the card that the process has been completed. This notification may have various data within it to allow the owner to see the grading score, the card information, where damage or wear was identified, or the like.

The program(s) and module(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

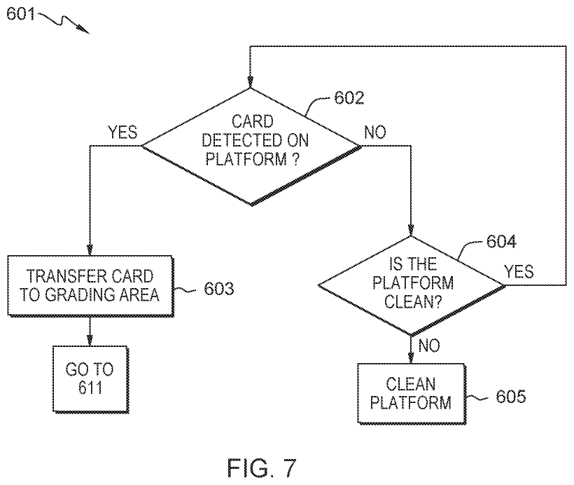

FIG. 7 shows the process flowchart of the input process 601. The grading module 104 detected if a card or a collectible (hereinafter “card”) is placed on the platform (decision 602). If the grading module 104 determines that a card is not on the platform, the grading module 104 determines if the platform is clean (decision 604), if the platform is clean, the grading module 104 continues to determine if a card is detected (decision 602). If the platform needs to be cleaned (step 605), the grading machine 105 may automatically clean the platform with internal tools or components. In some embodiments, the operator may need to clean the platform of dust or debris. When the grading module 104 detects a card on the platform, the grading module 104 activates the grading machine's 105 platform to transfer the card (step 603) to the grading area. In one embodiment, the grading machine 105 has a linear actuator to transfer the card and the platform from the receiving position to the scanning position.

In one embodiment, the grading machine 105 platform moves in an omnidirectional motion to transfer the card into and out of the grading machine 105. In some embodiments, the platform may move in a linear motion to transfer the card to the grading area. In other embodiments, the platform may be able to rotate or articulate in various dimensions. In other embodiments, the card is secured to the platform, so that as the platform moves from the receiving position to the grading position, the card is not able to move or shift. In some embodiments, the platform has a suction feature to secure the card in place. In other embodiments, the platform is designed with raised areas and section to fit the card at a predetermined orientation or position. Once the grading module 104 determines that the platform is within the grading area the next steps begin.

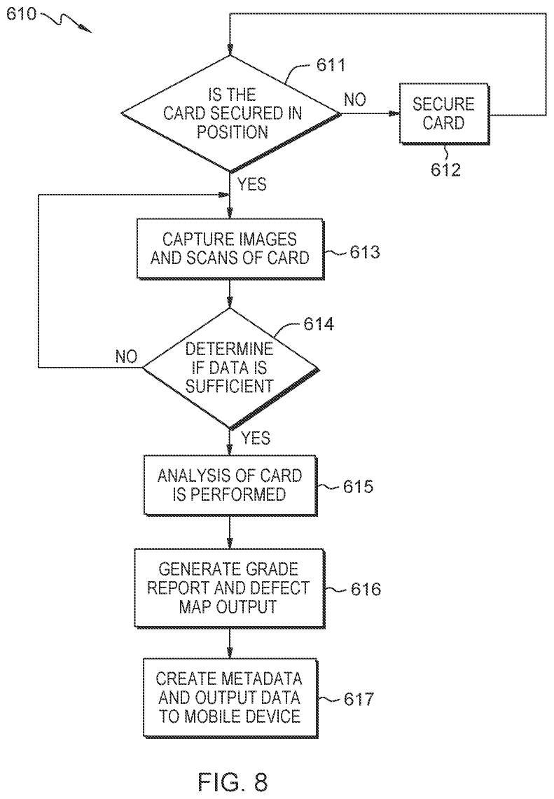

FIG. 8 shows the process flowchart of the grading steps. The grading module 104 determines that the platform is in position (decision 611) to begin the grading process, and that the card is secured in a predetermined position and orientation. If the grading module 104 determines that the card is not secured or positioned correctly, the grading module 104 either has the grading machine 105 return the platform so that an operator can adjust the card or the grading module 104 instructs the grading machine 105 to reposition or secure the card (step 612) through an autonomous process of either moving the platform or moving the card. In some embodiments, the positioning of the card may not need to be adjusted based on the cameras, sensors, lasers, etc. which will capture the images of the card. In additional embodiments, the grading module 104 determines if the sensors, light sources, and cameras are calibrated correctly, and confirms the calibration of the sensors and cameras of the grading machine 105.

If the grading module 104 determines that the card is in position and secured, the grading module 104 instructs the grading machine 105 to commence the capturing of the images and scans of the card (step 613). The grading machine 105 has various cameras, sensors, lasers, lights, and the like to analyze all surfaces of the card and all edges of the card. The grading machine 105 taking multiple images of the card with different light sources and brightness of light relative to the card's position. In some embodiments, the card is rotated to allow the front, back, sides, and edges to be scanned and photographed. Additional photos and data may be collected at various angles of the card within the grading machine 105 to detect the surface structure of the card. By modulating lighting conditions within a controlled environment, the grading machine 105 is able to generate a multitude of visualizations of the card, including a 3D scan of the card. The laser scanner that is able to generate millions of unique data points per card that are not influenced by ambient light, focal length, and provide a topographical map of the card. The laser sensor also has a 99% repeatability factor per scan at one (1) micron. In effect, the laser generates a fingerprint of each card. This fingerprint provides an anti-forgery feature to the system as a whole.

The grading module 104 determines if the grading machine 105 is able to capture the entire card via the cameras and sensors, and provides a warning if one of the sensors or cameras cannot see the entire card. This may happen at predetermined times during the scanning process or if the grading module 104 determines that the card has moved of shifts from its original position.

The grading machine 105 may be equipped with an inertial measurement unit to detect when the platform is at the desired position and angle. Once inside the grading machine 105, the platform may have the ability to move forwards, backwards, up, down, left, right, roll, adjust its pitch, and adjust its yaw to allow the cameras and sensors to capture the necessary images and scans of the card. The platform may also be able to flip over or rotate about an axis as well.

Once the grading machine 105 has completed the scans and collected the images of the card, the grading module 104 determines if the collected scans and images are of high enough quality to properly perform the analysis (decision 614). In this decision, the grading module 104 determines if there are any issues with the data which would negatively affect the accuracy of the grading process. This may be due to a blurry picture, incorrect lighting, a corrupt file, an inaccurate or incomplete scan, or other corrupt or inaccurate data. If the data received meets the requirements to proceed with the analysis, the grading module 104 performs the analysis of the card (step 615) to calculate the grade of the card. If the data collected is incorrect or not meeting a minimum standard, the card is rescanned (step 613) and new images are taken.

The grading module 104 performs the analysis of the card (step 615) by taking the collected data and analyzing the data. First a plurality of images are created of the card via the cameras, and a set of data is created by the sensors about the card, and the 3D model of the card is created. Image processing routines will process the images and the data and determine if there are any defect in the card. The grading module 104 using artificial intelligence to analyze the collected data identify defects or issues with the card based on known defects or issues with previously graded cards. The grading module 104 is also able to effectively grade “new” or previously “unseen” cards with high degree of accuracy based on the known card scans. A “new” or “unseen” card may be, for example a Pokemon® trading card if the grading module 104 has only ever graded baseball cards. The data collected from the baseball cards is used in a modified embodiment for the new card design and type. Given that baseball cards and Pokemon® cards will have different overall design, construction, and features the grading module 104 is not grading all the cards based on a restrictive baseline, and adjusts for different card types.

The defects are, but not limited to, surface abrasions, scratches, scuffing, loss of gloss, discoloration, printing defects, chipping, creases, missing pieces, discoloration, damages to the corner or edges, stains, centering of the card, trimming, recoloring, restoration and/or cleaning or other alteration from its original state, centering, edge condition, corner condition, and surface conditions such as bends, tears, stains, scratches, discolorations, cuts, color fading, alterations, re-coloring, bleaching of image and/or card, chips, dents, added color to fill in areas of defect, printing errors, the effects of bleaching and other chemical modifications, alterations in general (cutting the edges/corners of the card), stain removal, the addition of material (i.e., paper stock) or other material and image removal for the purpose of altering the width of the collectible's borders to re-center the collectible. The grading module 104 detects the residual of the card; this is used to measure missing quantities or how close an edge or a corner of the cardstock comes to the mathematical or perfect lines that define the edge and the corner. The grading module 104 detects the fill of the card, wherein the fill refers to the extent to which the cardstock is present throughout the mathematically or perfectly defined corner or edge. The grading module 104 may also detect the fray of the card, wherein the fray refers to the fall-off in the card near the corner.

The raw data from the sensors and cameras are processed using artificial intelligence models to identify defect subcategories throughout the card as numeric values. These numeric values are then analyzed and compared to a wider proprietary data set to identify the “grades” (1-10) for each subcategory of the card. The data collected and generated is stored in the database 114.

In additional embodiments, the grading module 104 uses blockchain technology to create a fully transparent public ledger of all information, grades, authentications, submissions, sales and pricing for all collectibles is proposed as a support infrastructure for the scanning process. As soon as collectibles are sent in for processing by the grading machine 105, a blockchain record is updated from the point of digital and physical submission to scanning, stickering, slabbing, and vaulting or shipment back to the client who made the submission.

In some embodiments, the artificial intelligence models rely on trained data, which is generated by a separate interface and computational process. Every new card scan, final grades and new training data are generated. This “annotated”, or trained data is made available to a multitude of human operators, which may edit selections made by the artificial intelligence. Once final edits are made by humans, the artificial intelligence models are updated and improved. This ensures the artificial intelligence constantly improves in terms of accuracy and precision especially as new collectibles are generated. In these embodiments, cards of known grades are scanned and this data is used to train the artificial intelligence to identify these defects and card features.

In performing the analysis of the card, the grade of the card is generated from the analysis. The necessary scales and tolerances will calculate a 1-10 grade and will assign that grade to the appropriate collectible based on the predefined grading condition criteria and overall grade adjustment rules. The variance of the scale can be changed depending on where on the scale the grade is located. The type of defect, the severity of the defect, and the location of the defect on the card also have an impact on the overall grade as well.

With the various images which are captured and scans which are performed by the sensor, the grading module 104 is able to detect any discrepancies of the card against a known card, if the same card was scanned prior and the data is stored. In some embodiments, a composite image is created of overlaying the scanned card with the previously scanned card to detect additional defects or provide further data to improve the rating of the present card.

The grading module 104 generates the card report and defect map output (step 616) to the database 114. This card report is created using metadata (step 617) which is provided to the mobile device 103 in a prefabricated design to allow the owner of the card to see the grading score, and additional information related to the grading score. This may be through a mobile application or via a webpage or the like, which is accessible to the owner. The information provided may include a report about the defects of the card to assist the owner with understanding the reason for the grade given.

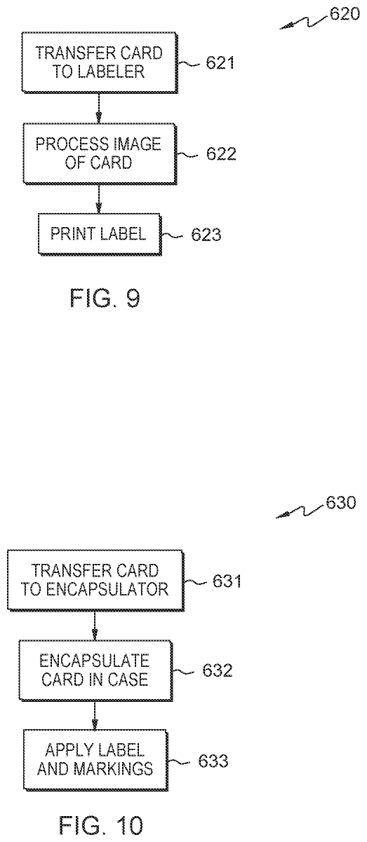

FIG. 9 shows the process flowchart of the labeling steps. The card is transferred to the labeling machine (step 621). This may be an manual process or may be autonomous based on the system design. The grading score which was generated in the previous steps is provided to the grading module 104, which provides the information to the labeling machine 10. If the grading score and related data is not extracted, then the images are processed again to find any other relevant information using image processing methods either missing or as a recheck. The process then checks if the grading is complete (step 622) and if not, it waits for the image processing to complete. Then the labeling machine 10 collects and arranges all the necessary predefined information, grading score, card information, Quick Response (QR) code, assigned serial number etc., and prints the information on the label at designated location and translates the printed label (step 623). The QR code is a type of matrix barcode or a two-dimensional barcode that is generally used in product tracking, item identification, time tracking, document management, and general marketing. In some embodiments, the printed label is applied to a designated location on the slab. The unprinted label will be in a roll similar to a ticket roll, which will be sliced or cut off into the desired position and size. In some embodiments, where the slab is etched with specific information, the labeling machine 10 or the encapsulating machine 107 may etch or mark the slab case. The data is saved and stored into a database 114 to be used for detecting regrading and to aid in the process of grading similar collectibles and to assist the grading module 104 in further refining the grading analysis.

In some embodiments, when the cards are submitted to the facility which is grading them, the submission, the order of the submission, and each card in the submission is given a identifying information or data. An order can contain a set of cards or a single card. Prior to scanning, during the submission process which occurs on the mobile application or website the owner inputs cards from our database into their order. When the order is received the cards are labeled by their certificate number and all the cards are stored in a specific location based on the order number. Once the labeling step begins, a database lookup based on the order number is performed and included in the labels. Each label has metadata including the certificate number.

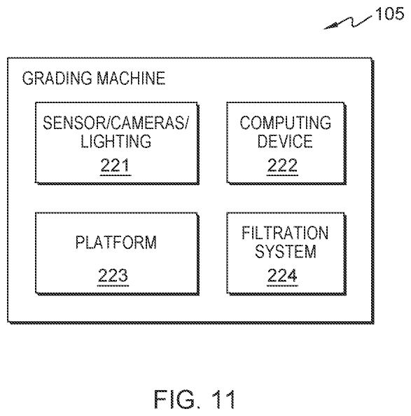

FIG. 10 shows the process flowchart of the encapsulating steps. The card may be placed autonomously based on the system design or by the operator (step 631). The label created in the previous step is placed on the slab at the predetermined location either autonomously or by the operator. The mating half of the slab is then positioned over the slab with the card and label in place, and are fitted together to form a water tight and air tight seal (Step 632). This can be accomplished by a pressure fit of the two halves, or by a standard sonic welding. The encapsulating machine 107 checks if the label is placed in the predetermined location, and the card is placed in the predetermined location. If not, the label or the card are not positioned correctly the machine will not encapsulate the card and will provide a warning to the operator, or will reposition one or both items to the correct location. The encapsulating machine 107 then mechanically places the top half of the case on top of the bottom half with the label inside and secures the two halves together (step 633). Once the card is encapsulated in the slab, the encapsulating machine 107 is reset for the next card/label and then the card is moved to the output section.

In some embodiments, the encapsulating machine 107 etches the case to include additional information and markings. In some embodiments, the encapsulating machine 107 stamps down the halves of the case and seal the card and label inside using standard industry sonic welding techniques. A force detection unit will measure the applied force of the hydraulic/pneumatic press to the slab to perform consistent and adequate seals. Slabs are commonly forged by criminals seeking to profit by swapping low value cards for high value cards. In order to avoid this, it is important to implement a security system to differentiate slabs that is both difficult to replicate and simple to identify. In the primary embodiment of slab security, a high-powered laser cutter is used to mark a unique code inside of each slab at precise points along the interface between male and female slabs during or after the main manufacturing process (outside of the scanning and grading process). In other embodiments, a microscopic code may be etched into the front or back of the slab during or after the main manufacturing process. With a simple magnifying tool, the code may be viewed and confirmed with an online record of the code available by the reference URL on the slab sticker (correlated by the ID of the card displayed in the metadata on the sticker).

In the output 650, the encapsulation machine 107 checks whether the encapsulation process is complete. If it is not complete, it waits for the process to complete. Once the encapsulation process is complete, the encapsulated card is removed (either manually or autonomously) from the encapsulation area. The user or operator can then go and just pull the graded, labelled, and encapsulated card out. In some embodiments, where this process is autonomous, the encapsulation machine 107 is configurable to stack the cards as needed or place them individually in the extraction area. The device will be able to stack the cards to a certain number, or to a certain height so that a user can pick or collect a stack at a time rather than picking them individually. In some embodiments, after the insertion of a card at the input to grade into the machine, the user interaction comes back at output to collect the card or cards which are graded, labelled, and encapsulated. Everything between placing the card in at the input step and taking the card out at the output step is a fully autonomous process.

In additional embodiments, this process can be performed on multiple cards at once, given the abilities of the grading machine 105, the labeling machine 10, and the encapsulating machine 107. The grading machine 105, is modified to support a multitude of cards for scanning, flipping, labeling, and slabbing at one time. This is done by horizontally scaling the sensor and tray assemblies as well as the machine necessary for labeling and slabbing. Alternatively, the machine configuration may be reconfigured similar to an assembly line for more efficient process automation.

In additional embodiments, the entire process can be automated with the necessary equipment to transfer the card from one machine to the next.

As depicted in FIGS. 11-15, in accordance with one embodiment of the present invention, the grading machine 105 is shown. Depicted in FIG. 11 is a block diagram of basic components of the grading machine 105. This includes the sensors/cameras/lights, 221 which are used to capture the images of the card. The platform 223 which the card is placed and repositioned the card under the sensors/cameras/lights 221. The computing device 222 which process the data collected and contains the grading module 104. In some embodiments, a filtration system 224 may be integrated into the grading machine to make sure the internal compartment is clean of dust a debris which could affect the images and scans.

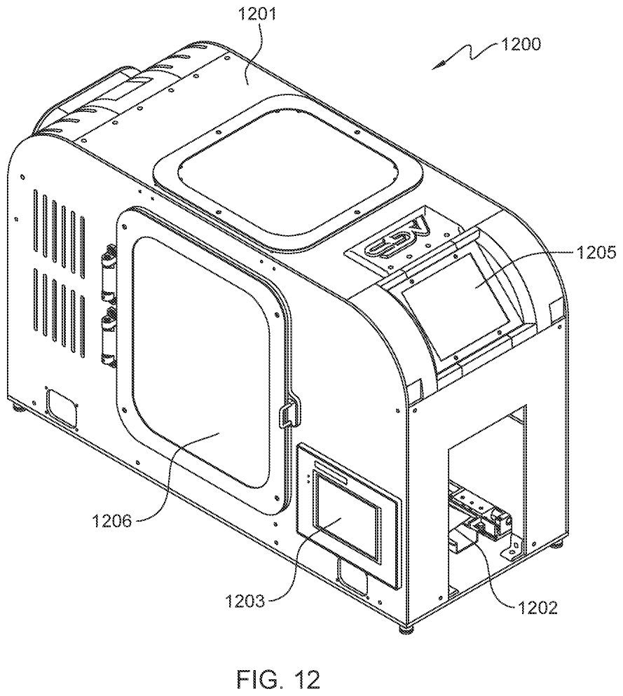

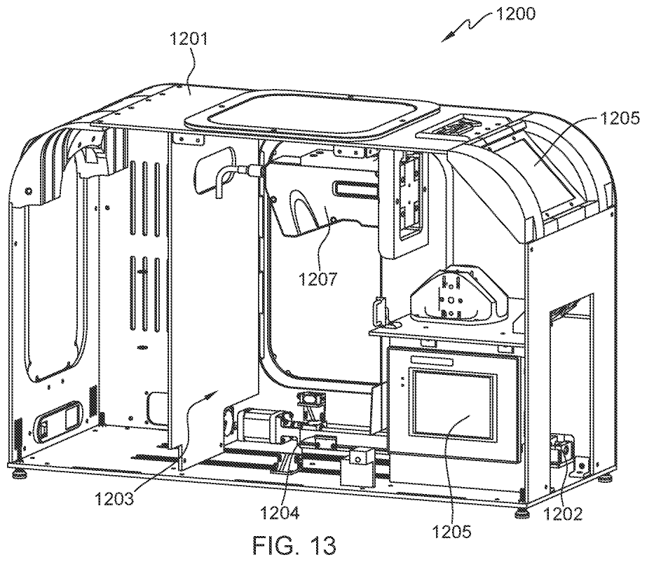

As depicted in FIGS. 12 and 13, a first embodiments of grading machine 1200 designs, according to one embodiment of the present invention is shown. The grading machine 105 has an exterior frame 1201 which has an access door 1206, LCD screens 1205 and 1203, and the platform 1202 which is accessible externally. Internally the rails and motors 1204 which control the platform 1202 are present, and the cameras/sensors/lights 1207 are positioned in predetermined locations within a scanning area 1206 based on the platform 1202 and the rails and motors 1204.

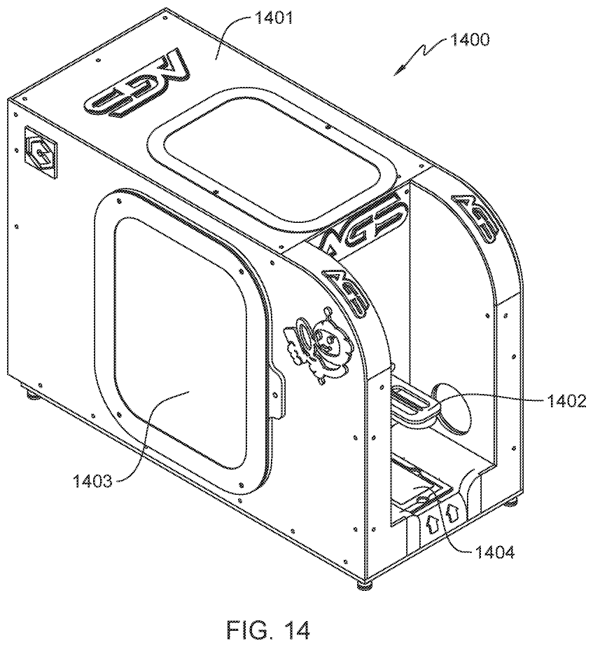

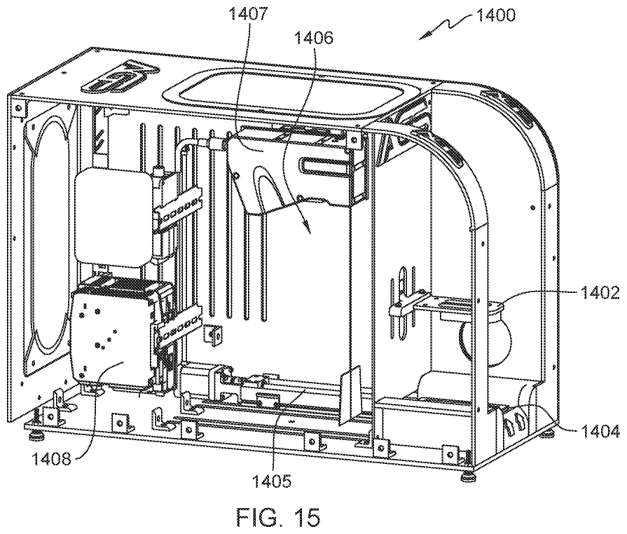

Depicted in FIGS. 14 and 15, a second embodiment of the grading machine 1400 is show, in accordance with one embodiment. The grading machine 1400 has an exterior frame 1401 to protect the internal scanning area, at least one access window 1403, a platform 1404, and a card rotation mechanism 1402. The card rotation mechanism 1402 allows for the ability to rotate the card without any human interaction after a first scan of the card is completed and the card needs to be flipped over to capture the back side. Internally the grading machine 1400 has a computing device 1408, cameras/sensors/lights 1407, a scanning area 1406, and a rail/actuator assembly 1405 for the platform 1404 to be moved along.

Generally, the platform translated along track underneath the sensors and cameras. Once data is collected and it reaches the end of the track, the platform actuates to flip or rotate the card or collectible around via mechanical means, and the platform travels back along the track returning to its original position, so that the sensors and cameras can capture different angles of the card or collectible. The platform may be able to rotate or tilt relative to the track. This can happen a number of times to capture a complete scan of the entire card or collectible. For example, a card may make 3 or 4 passes to capture the front, back, and edges of the card for analysis. A more complex or 3D collectible may require additional passes.

The flipping or rotating of the card or collectible may be accomplished by a mechanical device that is able to rotate the card or collectible, or is able to secure the card or collectible to the platform, while the platform rotates. In other embodiments the platform may contain openings to draw in air, generating a suction force that keeps the card or collectible on the platform.

The platform can be lined with non-adhesive, non-staining, and dust resistant materials ranging from metals to fine cloth. The platform contains holes for comfortable handling of card or collectible onto the platform.

The internal compartment of the grading machines where the platform is transferred to is where the cameras, sensors, and lights are integrated into the grading machine. The positioning and quantity of each camera, sensor, or light is based on the size of the internal compartment. In some embodiments, a LCD screen is positioned on the exterior of the grading machine to allow for manual override of the grading process or to present information about the grading process. The grading machine has a plurality of windows to, wherein at least one of the windows is hinged to allow access to the internal compartment of the grading machine Integrated into the grading machine is the computing device which controls the platform, sensors, cameras, lights, LCD screen and other electronic and mechanical-electronic components. In some embodiments, the grading machine has an internal power source, whereas in the depicted embodiments, an external power source is required.

At any point, the operator can use an interactive display to further investigate the captured images to manually inspect and review the card. Reviewing the card does not affect or influence the grading module's 104 grading in any way, ensuring that the processes remain autonomous and free of human interference. The card owner is able to access this information via their mobile device 103.

In another embodiment, the grading machine is able to clean the card or collectible which is placed on the platform. Through compressed air. The ports are positioned at a distance and set at a pressure so as to ensure cards are not damaged and dirt is cleaned. Air filtration systems are implemented within the grading machine and surrounding laboratory to ensure cleanliness along the entire process of grading.

In some embodiments, there is a “vault” for slabs which are not to be returned to their owners. The vault implements a process in which the fingerprint of each card slab assembly is linked on the blockchain and bound to a generated non-fungible token (NFT). The token serves as a digital representation of the slabbed card and effectively a claim to ownership, which may be sold or traded on any compatible exchange. In some embodiments, each time the NFT is sold or traded, royalties from each sale are awarded to the original owner and recorded on the blockchain. The grading module 104 is directly linked to the blockchain to not only serve as a log and public record, but also support this NFT feature. If the card is to be removed from the vault, the NFT or claim to ownership must be “burned” or destroyed in a process managed by the grading computational system via an online interface. The owner who decided to “burn” the NFT will then receive the physical card.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as may be being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method comprising:
receiving, by at least one processor, a notification that a card in received by a grading machine;
transferring, by the at least one processor, the card on a platform to a scanning area within the grading machine;
capturing, by the at least one processor, a set of data associated with the card via a plurality of sensors and cameras of the grading machine;
determining, by the at least one processor, that the set of data associated with the card is accurate and without errors;
analyzing, by the at least one processor, the set of data to identify defects of the card;
generating, by the at least one processor, a label based on the identified defects; and
encapsulating, by the at least one processor, the card and the label in a slab, wherein the slab contains identifying information.

2. The computer-implemented method of claim 1, wherein the received notification further comprises, identifying, by the at least one processor, that the card is positioned on a platform of the grading machine in a predetermined position;

3. The computer-implemented method of claim 1, wherein the collecting of the set of data includes images of varying lighting and scans of surfaces and edges of the card

4. The computer-implemented method of claim 1, wherein the grading machine receives a signal to reposition the card to capture additional images and scans of the card.

5. The computer-implemented method of claim 1, wherein a scan of the card identifies a surface structure of the card.

6. The computer-implemented method of claim 5, further comprising, integrating, by the at least one processors, the surface structure of the card into a readable code.

7. The computer-implemented method of claim 1, wherein the grade of the card is calculated based on the different identified defects.

8. The computer-implemented method of claim 1, wherein if it is determined that the set of data associated with the card is inaccurate or with errors, the card is reinserted into the grading machine and a second set of images and data associated with the card is collected.

9. A computer program product for grading a collectible, the computer program product comprising:
a computer non-transitory readable storage medium having program instructions embodied therewith, the program instructions executable by a computing device to cause the computing device to:
receiving a set of data associated with a collectible, wherein the set of data includes a plurality of images of the collectible and at least one scan of the collectible;
analyzing the set of data to determine if the accuracy of the plurality of images and the at least one scan is of a predetermined level;
calculating a set of grades of the collectible based on an analysis of the set of data, wherein the set of data is analyzed to identify defects and a severity of the identified defects;
converting the set of grades into an overall grade of the card and storing the set of grades and the overall grade; and
generating a label containing at least the overall grade.

10. The computer program product of claim 9, wherein when the set of data associated with the collectible contains a surface scan of the collectible.

11. The computer program product of claim 10, wherein the surface scan of the collectible is converted into data which is incorporated into the label.

12. The computer program product of claim 9, wherein the set of data associated with the collectible is compiled in a data base, and further comprising, using the set of data to train a module to detect defects in similar collectibles.

13. The computer program product of claim 9

14. A system comprising:
a grading machine for receiving a collectible and generating images and scans of the collectible by a series of image and data capturing devices and sensors;
a computing device comprising at least one processor for collecting the series of images and data;
a processing module to analyze the collected series of images and data to determine any defects or irregularities of the collectible and generate a data set;
a labeling machine, capable of receiving the data set and generate label; and
an encapsulating machine, wherein the collectible and the label are sealed within a tamper proof case.

15. The system of claim 14, further comprising, a scanner, wherein the scanner collected at least one image of the collectible within the tamper proof case.

16. The system of claim 14, wherein the grading machine, labeling machine, encapsulating machine, and scanner integrated into a single device.

17. The system of claim 14, wherein the collectible is at least one card.

18. The system of claim 14, wherein the collectible is autonomously transferred from one machine to the next.

19. The system of claim 14, wherein the grading machine has a platform for receiving the collectible, wherein the platform is able to translate from a first position to a second position.

20. The system of claim 19, wherein the platform is able to move in more than one axis.
